(19) United States
(12) Patent Application Publication
(10) Pub. No.: US 2006/0124690 A1
(43) Pub. Date: Jun. 15, 2006

(54) Device for ultrasonic welding

(76) Inventor: Klaus-Eckhart Dobernecker, Rodenbach 2 (DE)

Correspondence Address: ROBERT W. BECKER & ASSOCIATES, 707 HIGHWAY 66 EAST, SUITE B, TIJERAS, NM, 87059, US

(21) Appl. No.: 10/541,714

(22) PCT Filed: Sep. 10, 2004
(86) PCT No.: PCT/EP04/10151

§ 371 Date: Jul. 5, 2005

(30) Foreign Application Priority Data
Nov. 11, 2003 (DE) 103 52 929.2

(51) Int. Cl. B23K 1/06

(52) U.S. Cl. 228/1.1

(57) ABSTRACT

A device for ultrasonic welding of electrical conductors includes an ultrasonic oscillation-producing sonotrode and two anvils, which as viewed in radial cross section of the article to be welded, form a compression chamber defined by the sonotrade and the anvils for compressing and/or slightly deforming the article to be welded. The two anvils are supported to be moveable relative to one another, such that the two anvils during pivotal movement toward one another, at least partly perform also a displacement movement in the direction of the sonotrode.

The invention relates to a device for ultrasonic welding as well as to a corresponding use.

A plurality of different devices are known in the prior art, with which electrical conductors in the form of cords can be connected by compression.

Many times, with these devices, whereby the conductors to be connected are placed in a half-open chamber, the conductors are compressingly connected subsequently via a sonotrode, which produces sonic oscillations, and a counter electrode. The compression chamber is defined by the inner limiting surfaces of the sonotrode, the counter electrode, as well as further defining elements.

DE 37 10 603 C2 discloses a device for ultrasonic welding of wires or the like, whereby the device has an ultrasonic oscillation-producing sonotrode and two anvils which viewed in the welding state in cross section, in particular in radial cross section of the article to be welded, form a compression chamber defined by the sonotrode and anvils for compressing and/or slight deformation of the article to be welded, whereby the two anvils are supported to be moveable relative to one another.

A disadvantage is the fact that after complete pivoting of the two anvils onto one another, in many cases adequate welding after application of the corresponding ultrasonic energy does not take place.

The above device poses the problem of at least partly correcting or avoiding the problem associated with the noted disadvantage. The problem in particular comprises providing a device for ultrasonic welding of cable-, wire-, or cord-type articles and/or tubes, in particular, plastic tubes and/or corrugated tubes or the like made from metal or plastic, in which the typically occurring, inadequate welding by means of ultrasound is avoided.

This problem is resolved by a device according to claim 1 as well as by the uses according to claims 12 through 14.

The device of the present invention for ultrasonic welding of cable-, wire-, or cord-type articles and/or tubes in particular, especially plastic tubes and/or corrugated tubes or the like made of metal or plastic has: an ultrasonic oscillation-producing sonotrode and two anvils, which when viewed in the welding state in cross section, in particular in a radial cross section of the article to be welded, form a compression chamber defined by the sonotrode and anvils for compression and/or slight deformation of the article to be welded, whereby the two anvils are moveably supported relative to one another, whereby the device is characterized in that the two anvils upon pivoted movement toward one another at least partly perform also a displacement movement in the direction of the sonotrode.

In particular, it is critical that the two anvils upon pivotal movement toward one another at least partly perform also a displacement movement in the direction of the sonotrode, so that in practice with the inner surfaces of the two anvils and sonotrode accommodating the article to be welded and forming then the compression chamber which effects a forced fixing of the article, the article to be welded is pressed against the sonotrode, in order to provide a substantially improved energy transfer between the sonotrode and the article to be welded.

First, it is advantageous when the pivoting and displacement movements run in a synchronized manner, in particular when the device has a forced guidance for the anvils, such that upon exertion of a translatory force that moves the anvils in the direction of the sonotrode, simultaneously the anvils move toward one another or with exertion of a force pivoting the anvils away from one another, simultaneously the anvils are moved away from the sonotrode, since the article to be welded then experiences in practice a defined, predetermined forced guiding in the direction of the sonotrode, so that fluctuations in quality during welding are minimized. In particular, the design of a forced guidance represents a cost-effective embodiment compared to other possible synchronization via corresponding controls, for example by means of a servo motor.

In this regard, it is advantageous when the forced guidance has at least one take-up element for receiving the anvil areas, whereby the anvil areas can be an anvil leg and in particular, the take-up element can be a rotatable shaft, since these designs are cost-effective to realize. With this embodiment, by application of a translatory force onto the anvils, in particular the anvil leg, for movement of the anvil inner sides in the direction of the sonotrode, it is ensured that the anvil-areas on the take-up element, in particular the rotatable shaft, run alongside, and based on the geometric arrangement and design of the anvil areas, for example by projection into the direction of a longitudinal end, automatically a force-guided pivoting of both anvils toward one another takes place.

In addition, it is advantageous when the device of the present invention has a handle resembling a pistol grip, so that the device rests well in the hand, in order to make possible safe ultrasonic welding.

In addition, it is advantageous when the anvils are releasably attached, in order to take into consideration specific requirements with regard to the article to be welded and its profile-like design. In particular, it is advantageous when the inner sides of the anvils are concave, since in this manner, upon pulling in the direction of the sonotrode, a secure guiding/centering of the article to be welded takes place.

In addition, it is advantageous when the device has an actuating element, which upon actuation causes a movement of the anvils into a welding position, in which the article to be welded is fixed in the compression chamber, and upon reaching the welding position, ultrasonic energy is applied onto the article to be welded, in order to prevent or minimize in this manner eventual operating errors at the outset.

In addition, it is advantageous when a force is exerted permanently on the anvils via at least one adjusting element, in particular a spring element, especially when the spring element is biased between two anvil legs, since after a corresponding welding process, the two anvils automatically pivot to release the welded article and are opened apart from one another. In this regard, it is advantageous when the spring element pulls on both anvil legs.

The use of the device for ultrasonic welding of the present invention, in particular of electrical conductors in the form of cords as well as tubes, in particular plastic tubes and/or corrugated tubes, has the above-described advantages.

The anvils can be driven via piston cylinder units, in particular pneumatic cylinders (cylinders, which are driven via compressed air).

Next, one embodiment of the invention will be described with reference to the drawings, in which:

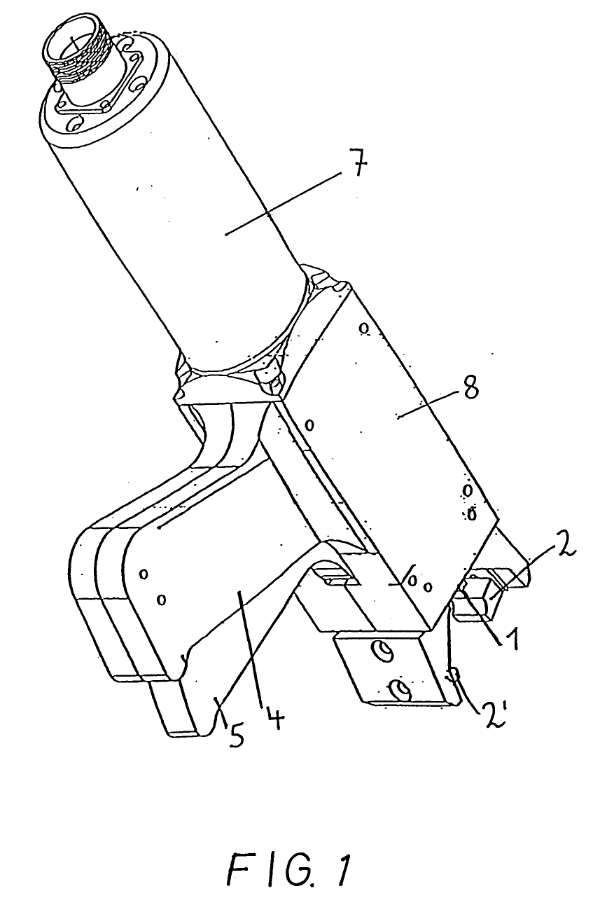

FIG. 1 shows a perspective view in a sketch of one embodiment of the device of the present invention;

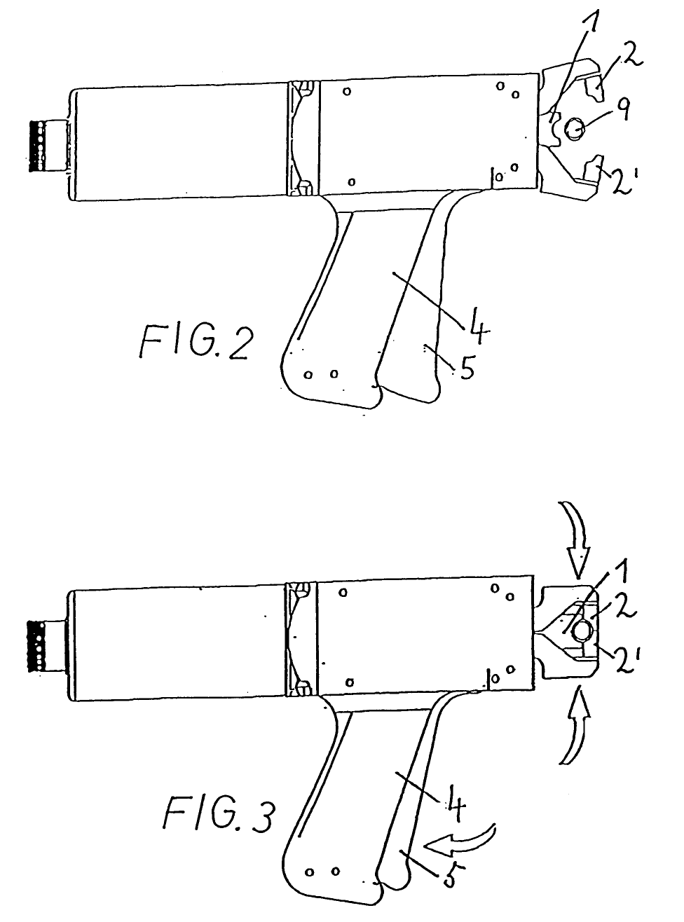

FIGS. 2 and 3 show a sketched cross sectional representation of the device shown in FIG. 1 in different stages of the welding process performed with this device; and

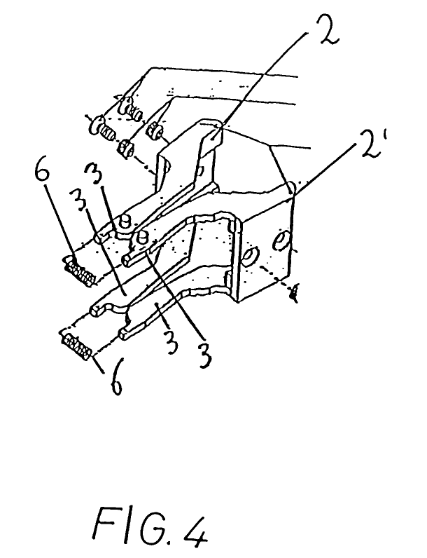

FIG. 4 shows a perspective, sketched representation of two anvils.

In FIG. 1, a perspective, sketched embodiment of the device of the present invention is shown. This has essentially an ultrasonic oscillation-producing sonotrode 1 and two anvils 2, 2′, which as viewed in the welding state in radial cross section of the article to be welded, form a compression chamber defined by the sonotrode 1 and the anvils 2, 2′ for compressing and/or slightly deforming the article to be welded, for example corrugated tubes made of plastic, whereby the two anvils 2, 2′ are mounted to be translatory and rotatably movable relative to one another and the inner sides of the anvils 2, 2′ are concave.

The sonotrode 1 is driven via a generator (not shown), which transfers its energy via a booster 7 to the sonotrode 1 disposed primarily in the housing 8. In addition, the device of the present invention has a handle 4 formed in the manner of a pistol grip, on which a grip-like actuating element 5 is disposed.

After placing a corrugated tube 9 to be welded into the opened compression chamber of the device of the present invention, the operator activates a drive (not shown) by actuating the actuating element 5 via a typical switch mechanism, for example by application of compressed air onto a cylinder-piston unit. The anvil legs shown in FIG. 4 are pulled along in the direction of the booster 7 on rotatable shafts (not shown) as the take-up element, so that in a type of forced guiding, both anvils 2, 2′ are moved pivotably toward one another simultaneously in the direction of the sonotrode 1, so that the concave inner sides of the anvils 2, 2′ come up against the article 9 to be welded and these are pressed then against the sonotrode 1, in order to apply quasi-automatically the necessary ultrasonic energy onto the article 9 to be welded via the sonotrode 1; this state, namely the welding state, is shown clearly in FIG. 3.

In this state, the spring elements 6, are compressed between the two anvil legs 3, whereby after automatic switching-off due to the tractive forces of the spring elements 6 the anvils 2, 2′ release the welded article and are pivoted apart from one another, moving away from the sonotrode. This state corresponds to that shown in FIG. 2.

1-14. (canceled)

15. A device for ultrasonic welding of electrical conductors, comprising:
a sonotrode that produces ultrasonic oscillations;
two anvils, wherein the two anvils when viewed in a radial cross section of an article to be welded form a compression chamber defined by the sonotrode and the anvils for compressing and/or slightly deforming the article to be welded, wherein the two anvils are supported to be moveable relative to one another, and wherein the two anvils during pivotal movement toward one another also at least partly perform a displacement movement in a direction toward the sonotrode.

16. The device of claim 15, wherein the pivoting and displacement movements are synchronized.

17. The device of claim 15, further comprising a forced guidance for the anvils, wherein upon exertion of a translatory force that moves the anvils in the direction of the sonotrode, simultaneously the anvils are moved toward one another, or upon exertion of a force that pivots the anvils away from one another, the anvils simultaneously move away from the sonotrode.

18. The device of claim 17, wherein the forced guidance includes at least one take-up element for receiving anvil areas.

19. The device of claim 18, wherein the take-up element is a rotatable shaft.

20. The device of claim 15, further comprising a handle having the form of a pistol grip.

21. The device of claim 15, wherein the anvils are releasably attached.

22. The device of claim 15, further comprising an actuating element, wherein upon actuation, the actuating element causes a movement of the anvils into a welding position, wherein in the welding position, the article to be welded is fixed in the compression chamber, and wherein upon reaching the welding position, ultrasonic energy is applied onto the article to be welded.

23. The device of claim 15, wherein a force that moves the anvils toward one another is exerted permanently onto the anvils via at least one adjusting element.

24. The device of claim 23, wherein the adjusting element is a spring element.

25. The device of claim 24, wherein the spring element is biased between two anvil legs.

26. A use of the device of claim 15 for ultrasonic welding.

27. A use of the device of claim 15 for ultrasonic welding of electrical conductors in the form of cords.

28. A use of the device of claim 15 for ultrasonic welding of tubes, in particular plastic tubes and/or corrugated tubes.
